(19) United States
(12) Patent Application Publication
(10) Pub. No.: US 2025/0110388 A1
(43) Pub. Date: Apr. 3, 2025

(54) LENS DRIVING APPARATUS, CAMERA MODULE, AND MANUFACTURING METHOD OF LENS DRIVING APPARATUS

(71) Applicant: ALPS ALPINE CO., LTD., Tokyo (JP)

(72) Inventors: Changxing WANG, Miyagi (JP); Hiroshi OSADA, Tokyo (JP); Masanobu MAEDA, Niigata (JP)

(21) Appl. No.: 18/896,100

(22) Filed: Sep. 25, 2024

(30) Foreign Application Priority Data
Sep. 28, 2023 (JP) 2023-168408

(51) Int. Cl. G03B 13/36; G02B 27/00; G03B 30/00

(52) U.S. Cl. CPC G03B 13/36; G02B 27/0006; G03B 30/00

(57) ABSTRACT

A lens driving apparatus includes a lens holding member configured to hold a lens body, a base member having an opening penetrating in a vertical direction thereof, the opening being at a position corresponding to the lens body, and an actuator configured to move the lens holding member relative to the base member, and a supporting member configured to support the base member, wherein the supporting member includes a base part disposed beneath the base member, and a tubular part protruding upward from an inner edge of the base part and disposed inside the opening, and a foreign matter capturing member having adhesiveness is disposed at a rim of the tubular part.

### BACKGROUND OF THE INVENTION

### 1. Field of the Invention

The disclosures herein relate to a lens driving apparatus mounted on, for example, a portable device with a camera.

### 2. Description of the Related Art

Conventionally, a lens driving apparatus including a lens holder (lens holding member) capable of holding a lens barrel (lens body), a base (base member) having an opening penetrating in a vertical direction thereof, the opening being at a position corresponding to the lens body, and an actuator to move the lens holding member relative to the base member has been known (Patent Literature (PTL) 1). In this lens driving apparatus, a dust trapping agent (foreign matter capturing material) is provided on the base member.

### CITATION LIST

### Patent Literature

[PTL 1] Japanese Laid-Open Patent Publication No. 2009-251517

### SUMMARY OF THE INVENTION

However, in the above-described apparatus, since the foreign matter capturing material is provided at a position away from the opening, there is a possibility that the foreign matter may enter the opening and reach an imaging sensor.

Therefore, it is desirable to provide a lens driving apparatus capable of more effectively preventing the foreign matter from reaching the imaging sensor.

A lens driving apparatus includes a lens holding member configured to hold a lens body, a base member having an opening penetrating in a vertical direction thereof, the opening being at a position corresponding to the lens body, and an actuator configured to move the lens holding member relative to the base member, and a supporting member configured to support the base member, wherein the supporting member includes a base part disposed beneath the base member, and a tubular part protruding upward from an inner edge of the base part and disposed inside the opening, and a foreign matter capturing member having adhesiveness is disposed at a rim of the tubular part.

The lens driving apparatus can more effectively prevent foreign matter from reaching an imaging sensor.

### BRIEF DESCRIPTION OF THE DRAWINGS

FIG. 1 is a perspective view of a camera module including a lens driving apparatus;

FIG. 2 is an exploded perspective view of the lens driving apparatus;

FIG. 3 is a perspective view of a coil, a lower flat spring and a conductive member composing the lens driving apparatus;

FIG. 4 is a top and bottom view of a case member composing the lens driving apparatus;

FIG. 5 is a cross-sectional view of the lens driving apparatus;

FIG. 6 is a drawing illustrating a procedure to provide a foreign matter capturing material in the case member; and

FIG. 7 is a drawing illustrating another procedure to provide a foreign matter capturing material in the case member.

### DESCRIPTION OF THE PREFERRED EMBODIMENTS

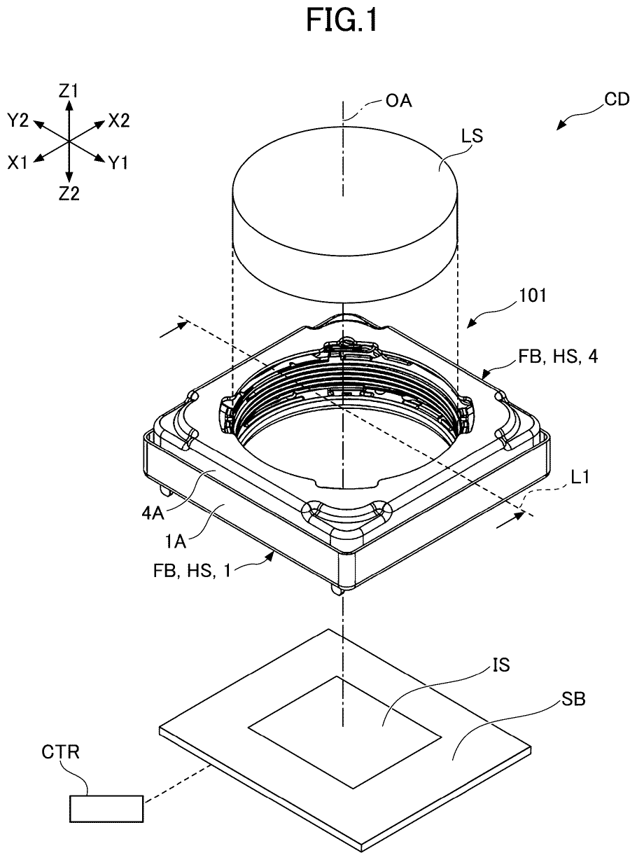

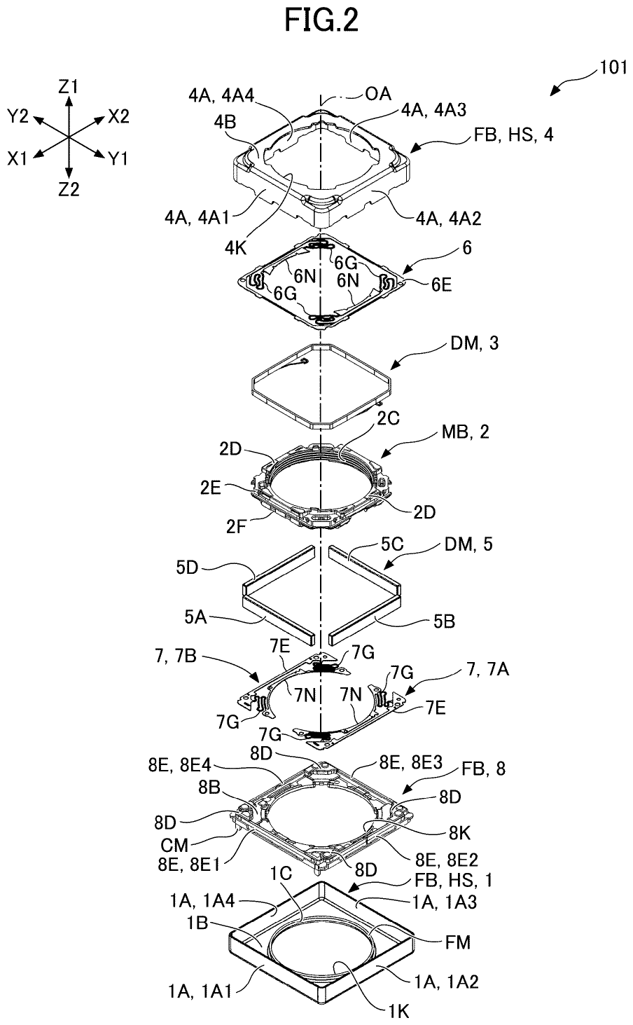

In the following, a lens driving apparatus 101 related to embodiments of the present invention will be described with reference to the accompanying drawings. FIG. 1 is a perspective view of a camera module CD including the lens driving apparatus 101. FIG. 2 is an exploded perspective view of the lens driving apparatus 101.

In FIGS. 1 and 2, X1 represents one direction of an X axis of a three-dimensional rectangular coordinate system, and X2 represents another direction of the X axis. Y1 represents one direction of a Y axis of the three-dimensional rectangular coordinate system, and Y2 represents another direction of the Y axis. Similarly, Z1 represents one direction of a Z axis of the three-dimensional rectangular coordinate system, and Z2represents the other direction of the Z axis. In FIGS. 1 and 2, the X1 direction of the lens driving apparatus 101 corresponds to a front (front face) of the lens driving apparatus 101, and the X2 direction of the lens driving apparatus 101 corresponds to a rear (rear face) of the lens driving apparatus 101. The Y1 direction of the lens driving apparatus 101 corresponds to a right face of the lens driving apparatus 101, and the Y2 direction of the lens driving apparatus 101 corresponds to a left face of the lens driving apparatus 101. The Z1 direction of the lens driving apparatus 101 corresponds to a top (facing a subject) of the lens driving apparatus 101, and the Z2 direction of the lens driving apparatus 101 corresponds to a bottom (facing an imaging sensor) of the lens driving apparatus 101. The same is true in other figures.

As shown in FIG. 1, the camera module CD includes a substrate SB, the lens driving apparatus 101, a lens body LS mounted on the lens driving apparatus 101, and the imaging sensor IS mounted on the substrate SB facing the lens body LS. The lens body LS schematically shown in FIG. 1 is, for example, a tubular lens barrel having at least one lens. In addition, the camera module CD may be connected to a control device CTR composed of a microcomputer including a CPU, a memory, and the like. In an illustrated example, the control device CTR is disposed outside the camera module CD, but may be disposed inside the camera module CD. As shown in FIG. 1, the lens driving apparatus 101 having a substantially rectangular parallelepiped shape is mounted on the substrate SB on which the imaging sensor IS is mounted.

Specifically, as shown in FIG. 1 and FIG. 2, the lens driving apparatus 101 includes a case member 1 and a cover member 4 which are part of a fixed lateral member FB. The case member 1 and the cover member 4 are configured to function as part of a housing HS covering other members. In the present embodiment, the case member 1 and the cover member 4 are made of a nonmagnetic metal. However, the case member 1 and the cover member 4 may be made of a magnetic metal or a synthetic resin.

Specifically, as shown in FIG. 2, the case member 1 has a rectangular tubular outer peripheral wall 1A and a rectangular annular flat base part 1B provided so as to be continuous with the lower end (end on the Z2 direction) of the outer peripheral wall 1A. A substantially circular opening 1K is formed in a center of the base part 1B. The outer peripheral wall 1A includes a first lateral plate 1A1 to a fourth lateral plate 1A4. The first lateral plate 1A1 and a third lateral plate 1A3 face each other, and a second lateral plate 1A2 and the fourth lateral plate 1A4 face each other. The first lateral plate 1A1 and the third lateral plate 1A3 extend perpendicularly to the second lateral plate 1A2 and the fourth lateral plate 4A4. The base part 1B is not limited to a flat plate shape, and may have a recess or a projection.

As shown in FIG. 2, the cover member 4 has the rectangular tubular outer peripheral wall 4A and a rectangular annular top plate 4B provided so as to be continuous with an upper end (end on the Z1 direction) of the outer peripheral wall 4A. A substantially circular opening 4K is formed in the center of the top plate 4B. The outer peripheral wall 4A includes a first lateral plate 4A1 to a fourth lateral plate 4A4. The first lateral plate 4A1 and the third lateral plate 4A3 face each other, and the second lateral plate 4A2 and the fourth lateral plate 4A4 face each other. The first lateral plate 4A1 and the third lateral plate 4A3 extend perpendicularly to the second lateral plate 4A2 and the fourth lateral plate 4A4. The top plate 4B has a recess formed at each of the four corners, but may be configured to have a flat plate shape or projections.

As shown in FIG. 1, the cover member 4 is joined to the case member 1 by an adhesive. The outer peripheral wall 1A of the case member 1 is disposed to partially cover the outer peripheral wall 4A of the cover member 4. However, the cover member 4 may be joined to the case member 1 by an electrically conductive adhesive, solder, welding, or the like.

As shown in FIG. 2, the housing HS contains a lens holding member 2, a coil 3, magnets 5, an upper flat spring 6, a lower flat spring 7, a base member 8, and the like. The lens holding member 2 is a member capable of holding the lens body LS (see FIG. 1) and is included in a movable lateral member MB. The lens body LS is disposed so that an optical axis OA is along a central axis of the lens driving apparatus 101.

The lens holding member 2 is formed by injection molding synthetic resin such as liquid crystal polymer (LCP). Specifically, as shown in FIG. 2, the lens holding member 2 includes a tubular part 2C formed to extend along the optical axis OA, an upper pedestal part 2D to which the upper flat spring 6 is attached, an outer peripheral part 2E around which the coil 3 is wound, and a lower pedestal part 2F to which the lower flat spring 7 is attached.

A spiral groove is formed on the inner peripheral surface of the tubular part 2C. This is to enhance the adhesive strength between the lens body LS and the tubular part 2C by the adhesive applied between the lens body LS and the inner peripheral surface of the tubular part 2C. The lens body LS may be configured to be screwed onto the inner peripheral surface of the tubular part 2C.

The coil 3 is a member of an actuator DM. The actuator DM is a means to move the lens holding member 2 with respect to the fixed lateral member FB. In the illustrated example, the coil 3 is wound around the outer peripheral surface of the outer peripheral part 2E of the lens holding member 2.

Magnets 5 are members of the actuator DM. In the illustrated example, the magnets 5 are bipolar magnetized magnets and include a first magnet 5A to a fourth magnet 5D. The magnets 5 are fixed to the inner peripheral surface of the outer peripheral wall 4A of the cover member 4 by the adhesive.

The base member 8 is formed by injection molding using a synthetic resin such as a liquid crystal polymer (LCP). In this embodiment, the base member 8 has a substantially rectangular outer shape in top view and has a circular opening 8K in the center. Specifically, the base member 8 has a rectangular annular base part 8B disposed so as to surround the circular opening 8K. The base part 8B has four edges 8E (a first edge 8E1 to a fourth edge 8E4). In addition, fixed lateral pedestal parts 8D to which lower flat spring 7 is attached are formed at four corners of the base member 8. The fixed lateral pedestal parts 8D are formed so as to project upward from the base part 8B of the base member 8. A conductive member CM is embedded in the base part 8B of the base member 8.

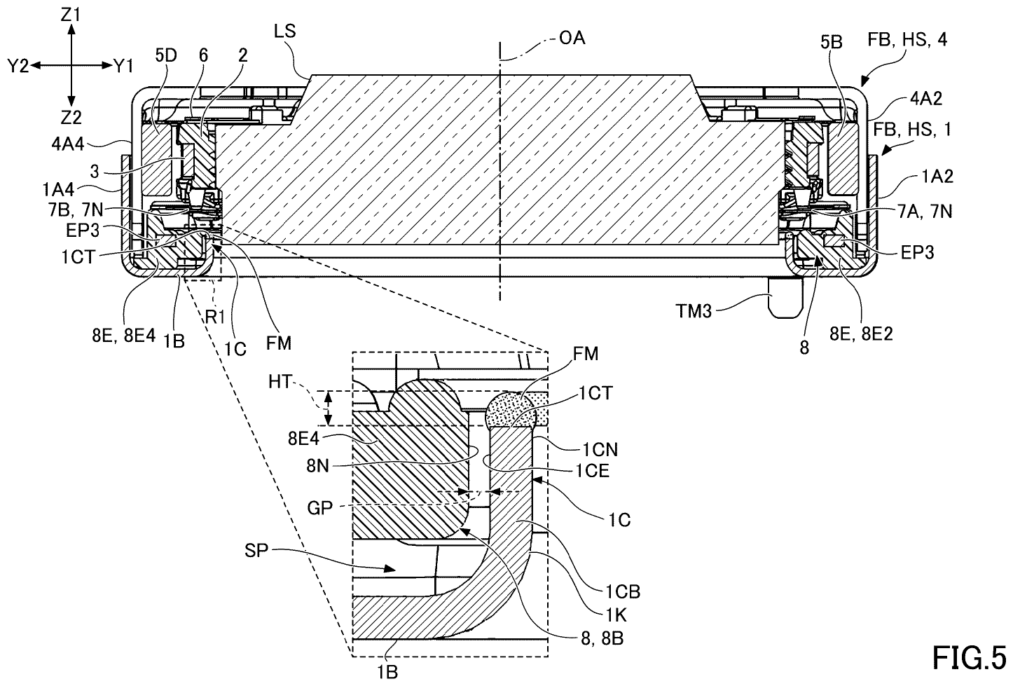

The base member 8 is integrated with the case member 1 (see FIG. 5). Specifically, the base member 8 is disposed on the upper surface of the base part 1B of the case member 1 and fixed to the case member 1 by an adhesive. That is, the case member 1 is included in a supporting member to support the base member 8.

The upper flat spring 6 is configured to support the movable lateral member MB (lens holding member 2) movably in the direction parallel to the optical axis OA with respect to the fixed lateral member FB (cover member 4). The lower flat spring 7 is configured to support the movable lateral member MB (lens holding member 2) movably in the direction parallel to the optical axis OA with respect to the fixed lateral member FB (base member 8).

The upper flat spring 6 is configured to connect the upper pedestal part 2D formed on the lens holding member 2 with the four corners of the cover member 4. The lower flat spring 7 is configured to connect the lower pedestal part 2F formed on the lens holding member 2 with the fixed lateral pedestal part 8D formed on the base member 8.

In the present embodiment, the upper flat spring 6 and the lower flat spring 7 are made of, for example, a metal plate mainly made of a copper alloy, a titanium-copper alloy (titanium-copper), or a copper-nickel alloy (nickel-tin-copper).

The upper flat spring 6 has an outer portion 6E fixed to the fixed lateral member FB (cover member 4), two inner portions 6N fixed to the movable lateral member MB (lens holding member 2), and four elastically deformable elastic arms 6G connecting the outer portion 6E to each of the two inner portions 6N. The outer portion 6E is fixed to the cover member 4 and the magnets 5 by an adhesive while being interposed between the upper surface of the magnets 5 and the ceiling surface (lower surface of the recess) of the cover member 4. The inner portion 6N is fixed to the upper pedestal part 2D of the lens holding member 2 by an adhesive.

The lower flat spring 7 includes a first lower flat spring 7A and a second lower flat spring 7B. Each of the first lower flat spring 7A and the second lower flat spring 7B has an outer portion 7E fixed to the fixed lateral member FB (base member 8), inner portion 7N fixed to the movable lateral member MB (lens holding member 2), and two elastically deformable elastic arms 7G connecting the outer portion 7E and the inner portion 7N.

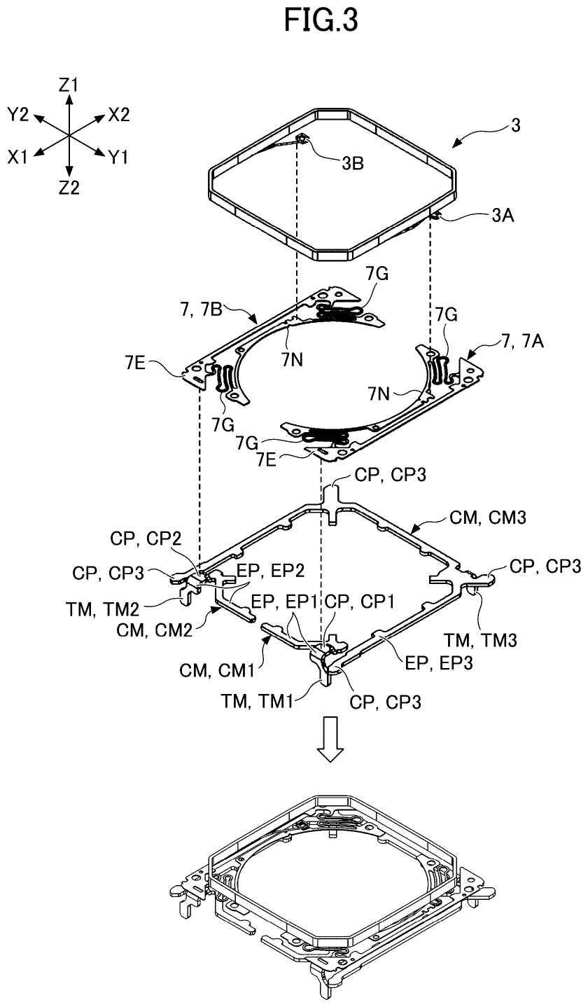

Referring now to FIG. 3, the path of the current flowing through the coil 3, that is, the connection relation between the coil 3, the lower flat spring 7, and the conductive member CM will be 20 described. FIG. 3 is a perspective view of the coil 3, the lower flat spring 7, and the conductive member CM. Specifically, the upper view (the view above the block arrow) of FIG. 3 is an exploded perspective view of the coil 3, the lower flat spring 7, and the 25 conductive member CM. The lower view of FIG. 3 (after the block arrow) is an assembled perspective view of the coil 3, the lower flat spring 7, and the conductive member CM, showing the positional relation between the coil 3, the lower flat spring 7, and the 30 conductive member CM in the lens driving apparatus 101.

The first end 3A of the coil 3 is fixed to the inner portion 7N of the first lower flat spring 7A by conductive adhesive, solder, welding, or the like (hereinafter referred to as “welding, etc.”), and the second end 3B is fixed to the inner portion 7N of the second lower flat spring 7B by welding, or the like.

The conductive member CM partially embedded in the base member 8 includes a first conductive member CM1, a second conductive member CM2, and a third conductive member CM3, as shown in FIG. 3.

Specifically, the conductive member CM has terminal parts TM (a first terminal part TM1 to a third terminal part TM3) protruding downward from the lower surface of the base member 8, exposed parts CP (a first exposed part CP1 to a third exposed part CP3) exposed from the surface of the base member 8, and embedded parts EP (a first embedded part EP1 to a third embedded parts EP3) embedded in the base member 8. The first conductive member CM1 has a first terminal part TM1, a first exposed part CP1, and a first embedded part EP1; the second conductive member CM2 has a second terminal part TM2, a second exposed part CP2, and a second embedded part EP2; and the third conductive member CM3 has a third terminal part TM3, four third exposed parts CP3, and a third embedded part EP3.

The outer portion 7E of the first lower flat spring 7A is fixed to the first exposed part CP1 of the first conductive member CM1 by welding or the like, and the outer portion 7E of the second lower flat spring 7B is fixed to the second exposed part CP2 of the second conductive member CM2 by welding or the like. The four third exposed parts CP3 of the third conductive member CM3 are fixed to the lower end of the corner portion of the outer peripheral wall 4A of the cover member 4 by welding or the like. The outer peripheral wall 4A of the cover member 4 is fixed to the outer peripheral wall 1A of the case member 1 by welding or the like.

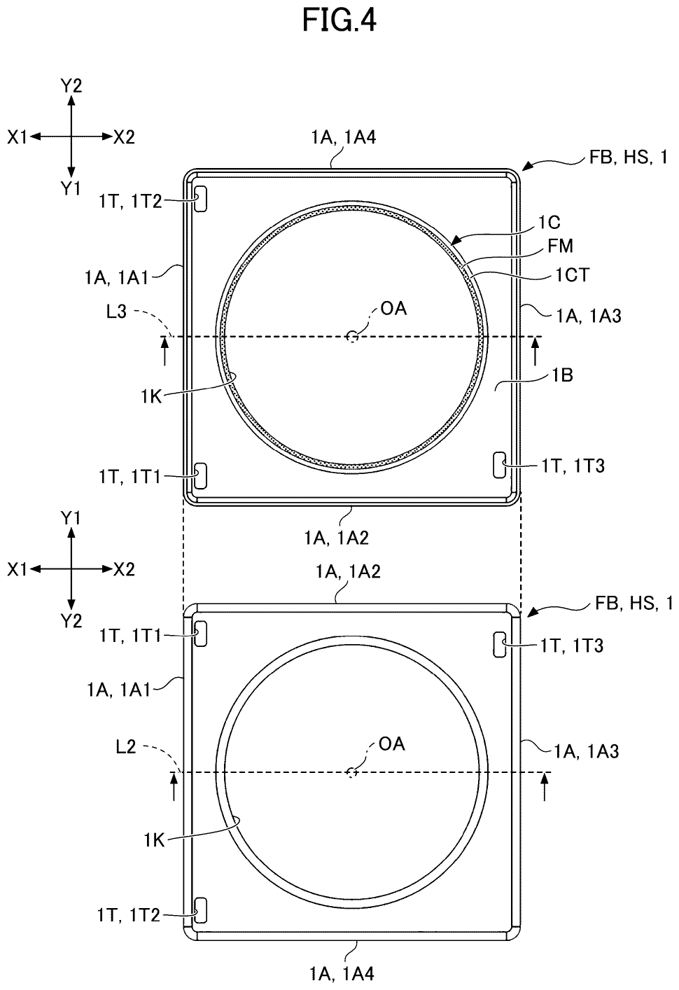

The terminal parts TM project downward through through-holes 1T (see FIG. 4) formed in the base part 1B of the case member 1, and are connected to the conductor pattern of the substrate SB. FIG. 4 is a top and bottom view of a case member 1. Specifically, as shown in FIG. 4, the through-holes 1T include a first through-hole 1T1, a second through-hole 112, and a third through-hole 1T3. The first terminal part TM1 projects downward through the first through-hole 1T1, the second terminal part TM2 projects downward through the second through-hole 1T2, and the third terminal part TM3 projects downward through the third through-hole 1T3.

With this configuration, when the first terminal part TM1 of the first conductive member CM1 is connected to a high potential and the second terminal part TM2 of the second conductive member CM2 is connected to a low potential, a current flows through the first terminal part TM1, the first embedded part EP1, and the first exposed part CP1 to the first lower flat spring 7A, and further flows through the outer portion 7E, the elastic arm 7G, and the inner portion 7N of the first lower flat spring 7A to the first end 3A of the coil 3. Thereafter, the current passing through the coil 3 flows to the second lower flat spring 7B through the second end 3B of the coil 3, flows to the second conductive member CM2 through the inner portion 7N, the elastic arm 7G, and the outer portion 7E of the second lower flat spring 7B, and further flows to the second terminal part TM2 through the second exposed part CP2 and the second embedded part EP2 of the second conductive member CM2. The same applies when the second terminal part TM2 of the second conductive member CM2 is connected to a high potential and the first terminal part TM1 of the first conductive member CM1 is connected to a low potential, except that the current flows in the opposite direction.

Therefore, the control device CTR can flow a current through the coil 3 by controlling voltages applied to the first terminal part TM1 and the second terminal part TM2, and can change the direction of the current flowing through the coil 3. Therefore, the control device CTR can move the movable lateral member MB (lens holding member 2) with respect to the fixed lateral member FB (magnets 5) along the optical axis OA by utilizing Lorentz force, which is a force acting on charged particles moving in a magnetic field generated by the magnets 5. By moving the lens holding member 2 in this manner, the control device CTR can realize an automatic focus adjustment function, which is one of the lens adjustment functions. Specifically, the control device CTR can realize macro photography by moving the lens holding member 2 in a direction away from the imaging sensor IS, and can realize infinity photography by moving the lens holding member 2 in a direction approaching the imaging sensor IS.

When the third terminal part TM3 of the third conductive member CM3 is grounded, the case member 1 and the cover member 4 are also grounded. This is because the four third exposed parts CP3 of the third conductive member CM3 are electrically connected to the lower end of the corner portion of the outer peripheral wall 4A of the cover member 4 by welding or the like, and the outer peripheral wall 4A of the cover member 4 is electrically connected to the outer peripheral wall 1A of the case member 1 by welding or the like.

Therefore, the control device CTR can remove electrical charges from the charged housing HS by controlling the grounding of the third terminal part TM3. Moreover, the control device CTR can realize an electromagnetic shield function by the housing HS composed of the case member 1 and the cover member 4.

In the illustrated example, the housing HS is configured such that the outer peripheral wall 1A of the case member 1 is positioned outside the outer peripheral wall 4A of the cover member 4, but the outer peripheral wall 1A of the case member 1 may be positioned inside the outer peripheral wall 4A of the cover member 4.

Next, with reference to FIGS. 4 and 5, a foreign matter capturing member FM which is a member to capture foreign matter in the housing HS of the lens driving apparatus 101 will be described. FIG. 4 is a drawing describing an example of a composition of the case member 1. Specifically, an upper drawing of FIG. 4 is a top view of a case member 1, and a lower drawing of FIG. 4 is a bottom view of a case member 1. FIG. 5 is a cross-sectional view of the lens driving apparatus 101. Specifically, the upper view of FIG. 5 is a cross-sectional view of the lens driving apparatus 101 in a virtual plane parallel to the YZ plane including the broken line L1 in FIG. 1, viewed from the X1 direction. The lower part of FIG. 5 is an enlarged view of the area R1 surrounded by broken lines in the upper part of FIG. 5.

The foreign matter capturing member FM is a member to prevent foreign matter in the housing HS of the lens driving apparatus 101 from passing through the opening 1K of the case member 1 and reaching the imaging sensor IS, and is also referred to as a dust-10 catching gel or a dust-proof adhesive. The foreign matter is typically dust or the like generated in the housing HS of the lens driving apparatus 101, and includes, for example, abrasion powder generated when the movable lateral member MB (lens holding member 2) 15 and the fixed lateral member FB (cover member 4, base member 8, etc.) come into contact with each other. The foreign matter also includes dust or the like generated outside the housing HS of the lens driving apparatus 101 and penetrated into the housing HS.

As shown in FIG. 4, the case member 1 has a base part 1B and a tubular part 1C protruding upward (Z1 direction) from the inner edge of the base part 1B and disposed outside the opening 1K. As shown in the lower drawing of FIG. 5, a foreign matter 25 capturing member FM having adhesiveness is disposed at the rim 1CT of the tubular part 1C.

In the illustrated example, as shown in the upper drawing of FIG. 5, the tubular part 1C is configured such that the rim 1CT is positioned above 30 the lower end of the lens body LS held by the lens holding member 2. However, the tubular part 1C may be configured such that the rim 1CT is positioned below the lower end of the lens body LS.

Further, the tubular part 1C is configured such that the rim 1CT is positioned below the upper surface of the edge 8E of the base member 8 in the illustrated example, but the rim 1CT may be positioned above the upper surface of the edge 8E of the base member 8.

In the illustrated example, the foreign matter capturing member FM is realized by curing the foreign matter capturing material RM, which is a flowable synthetic resin material, into a gel state. Specifically, the foreign matter capturing material RM is an adhesive made of synthetic resin, and is cured into a gel state by being irradiated with ultraviolet light while being applied to the rim 1CT of the tubular part 1C. The foreign matter capturing material RM cured into a gel state exhibits adhesiveness as the foreign matter capturing member FM. The foreign matter capturing material RM may be a material cured by a curing method other than ultraviolet curing, such as moisture curing, heat curing, or anaerobic curing.

The foreign matter capturing member FM is disposed to have an appropriate height HT so that the foreign matter capturing member FM and the movable lateral member MB (lens holding member 2 and lens body LS) do not come into contact with each other when the movable lateral member MB (lens holding member 2 and lens body LS) moves, and so that foreign matter does not pass through the opening 1K through the gap between the rim 1CT and the movable lateral member MB (lens holding member 2 and lens body LS).

Further, as shown in the lower drawing of FIG. 5, the case member 1 is configured such that a gap GP is formed between the tubular part 1C and the base member 8 in the radial direction of a circle around the optical axis OA. With this configuration, the case member 1 can take a part of the foreign matter into the space SP, and can prevent the foreign matter from passing through the opening 1K and reaching the imaging sensor IS. The space SP is a space formed between the upper surface of the base part 1B of the case member 1 and the lower surface of the base part 8B of the base member 8.

As shown in the upper drawing of FIG. 4, the rim 1CT of the tubular part 1C is formed continuously along the entire circumference of the tubular part 1C. The foreign matter capturing member FM is provided on the rim 1CT continuously along the entire circumference of the tubular part 1C. However, the rim 1CT of the tubular part 1C may be formed so as to include a partial recess or projection. Even in this case, the foreign matter capturing member FM is desirably provided continuously along the entire circumference of the tubular part 1C.

Further, as shown in the upper view of FIG. 4, the tubular part 1C is formed to have an annular shape in the top view, but may be formed to have a polygonal shape such as a square ring, a hexagonal ring, or an octagonal ring in the top view, or may be formed to have another shape such as an elliptical ring in the top view. Further, in the illustrated example, the case member 1 is configured to have a tubular part 1C extending along the optical axis OA, but may be configured to have a tubular part 1C which is a truncated conical tubular shape. That is, the tubular part 1C may be configured to have a different inner diameter at the rim 1CT and a different inner diameter at the lower end 1CB.

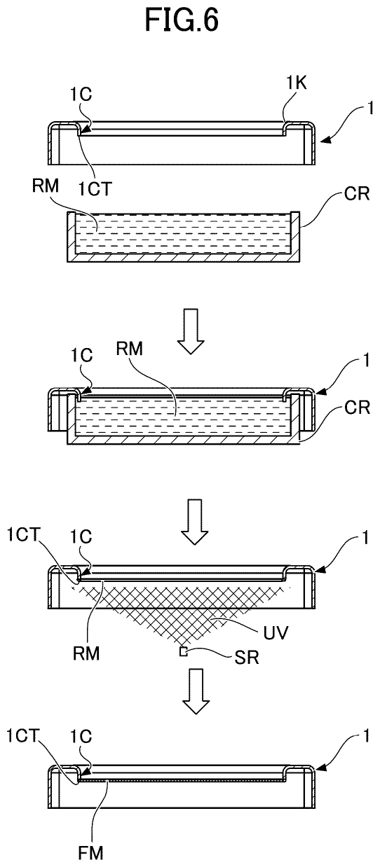

Next, referring to FIG. 6, a procedure to provide the foreign matter capturing member FM at the rim 1CT of the tubular part 1C of the case member 1 will be described. FIG. 6 is a drawing illustrating a procedure to provide a foreign matter capturing member FM at the rim 1CT. Specifically, four views (first state views to fourth state views) shown separately with block arrows interposed in FIG. 6 show states of the case member 1 that change with time. Moreover, the first state view to fourth state view include views of a cross section of the case member 1 turned upside down in a virtual plane parallel to the XZ plane including the broken line L2 in the lower drawing of FIG. 4, and viewed from the Y2 direction. The first state view and the second state view include cross-sectional views of the container CR containing the foreign matter capturing material RM.

The foreign matter capturing material RM is a synthetic resin material having fluidity, and is configured to be cured into a gel state by being irradiated with ultraviolet light UV to form a foreign matter capturing member FM having adhesiveness.

The container CR is a container to contain the foreign matter capturing material RM, and is also called a pool. In the illustrated example, the container CR is an open box-like container having a tubular wall surface. Specifically, the container CR has an outer diameter larger than the inner diameter of the opening 1K of the case member 1 and smaller than the width of the outer diameter of the case member 1. That is, as shown in the second state view, the container CR is configured so that the liquid surface of the foreign matter capturing material RM can be attached only to the rim 1CT without attaching the fluid surface (liquid surface) of the foreign matter capturing material RM to a portion other than the rim 1CT of the tubular part 1C.

First, as shown in the first state view, the case member 1 is moved to a position just above the container CR in a state where it is turned upside down.

Thereafter, the case member 1 is lowered so that the rim 1CT of the tubular part 1C is attached to the liquid surface of the foreign matter capturing material RM contained in the container CR. As shown in the second state view, the rim 1CT is immersed in the foreign matter capturing material RM contained in the container CR. In the illustrated example, the rim 1CT is immersed in the foreign matter capturing material RM so that the foreign matter capturing material RM adheres not only to the rim surface but also to the inner surface 1CN and the outer surface 1CE as shown in the lower drawing of FIG. 5.

Thereafter, the rim 1CT to which the foreign matter capturing material RM adheres is pulled up from the liquid surface of the foreign matter capturing material RM and is moved just above the light source SR capable of emitting ultraviolet light UV. The foreign matter capturing material RM adheres to the rim 1CT pulled up from the liquid surface of the foreign matter capturing material RM. By this procedure, the foreign matter capturing material RM is applied to the rim 1CT of the tubular part 1C. This step of applying the foreign matter capturing material RM to the rim 1CT is referred to as applying.

Thereafter, the rim 1CT to which the foreign matter capturing material RM adheres receives ultraviolet UV irradiation from the light source SR, as shown in the third state view. The foreign matter capturing material RM that receives the ultraviolet UV irradiation hardens into a gel state and becomes a foreign matter capturing member FM having adhesiveness, as shown in the fourth state view. The foreign matter capturing material RM applied to the rim 1CT is cured by such a procedure. This step of curing the foreign matter capturing material RM is referred to as curing.

The foreign matter capturing material RM is applied to the rim 1CT of the tubular part 1C of the case member 1 by such a series of procedures, and the foreign matter capturing material RM applied to the rim 1CT is irradiated with ultraviolet light UV and becomes a gel-like foreign matter capturing member FM having adhesiveness.

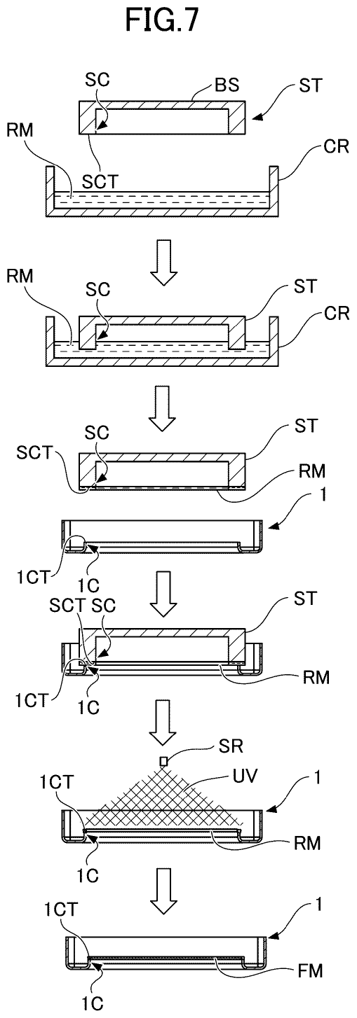

Next, another procedure for providing the foreign matter capturing member FM at the rim 1CT of the tubular part 1C of the case member 1 will be described with reference to FIG. 7. FIG. 7 is a drawing illustrating another procedure to provide a foreign matter capturing member FM in the rim 1CT. Specifically, six views (first state view to sixth state view) shown separately with block arrows in FIG. 7 show states of the case member 1 that change with time. The third state view to sixth state view include view of a cross section of the case member 1 in a virtual plane parallel to the XZ plane including the broken line L3 in the upper view of FIG. 4 when viewed from the Y1 direction. The first state view and the second state view include cross sections of the container CR containing the foreign matter capturing material RM, and the first state view to fourth state view include cross sections of a stamper ST.

The stamper ST is a member used to adhere the foreign matter capturing material RM to the rim 1CT of the tubular part 1C of the case member 1, and corresponds to a pad used in pad printing. In the illustrated example, the stamper ST is a bottomless box-shaped member having a tubular wall surface, and has a base part BS and a tubular part SC protruding downward (toward Z2) from the outer edge of the base part BS.

First, as shown in the first state view, the stamper ST is moved to a position immediately above the container CR.

Thereafter, the stamper ST is lowered so that the rim SCT of the tubular part SC attaches to the fluid surface (liquid surface) of the foreign matter capturing material RM contained in the container CR. Then, as shown in the second state view, the rim SCT is immersed in the foreign matter capturing material RM contained in the container CR.

Thereafter, the rim SCT to which the foreign matter capturing material RM is attached is pulled up from the liquid surface of the foreign matter capturing material RM and is moved directly above the case member 1. Specifically, as shown in the third state view, the stamper ST is disposed so that the rim SCT of the tubular part SC and the rim 1CT of the tubular part 1C of the case member 1 face each other in the vertical direction.

Thereafter, the stamper ST is lowered so that the rim SCT of the tubular part SC and the rim 1CT of the tubular part 1C come into contact with each other. When the stamper ST is lowered, the rim SCT to which the foreign matter capturing material RM is attached comes into contact with the rim 1CT as shown in the fourth state view.

Thereafter, the stamper ST is separated from the case member 1, but the foreign matter capturing material RM attached to the rim SCT of the tubular part SC is transferred to the rim 1CT of the case member 1, and the foreign matter capturing material RM is attached to the rim 1CT.

By such a procedure, the foreign matter capturing material RM is applied to the rim 1CT of the tubular part 1C. This step in which the foreign matter capturing material RM is applied to the rim 1CT is referred to as applying.

Thereafter, the case member 1 is moved directly below the light source SR capable of emitting ultraviolet light UV.

Thereafter, as shown in the fifth state view, the rim 1CT to which the foreign matter capturing material RM is attached is irradiated with ultraviolet light UV from the light source SR. As shown in the sixth state view, the foreign matter capturing material RM irradiated with ultraviolet light UV is cured into a gel-like foreign matter capturing member FM having adhesiveness. By such a procedure, the foreign matter capturing material RM applied to the rim 1CT is cured. This step of curing the foreign matter capturing material RM is referred to as curing.

By such a series of procedures, the foreign matter capturing material RM is applied to the rim 1CT of the tubular part 1C of the case member 1, and the foreign matter capturing material RM applied to the rim 1CT is irradiated with ultraviolet light UV and becomes a gel-like foreign matter capturing member FM having adhesiveness.

As described above, a lens driving apparatus 101 according to an embodiment of the present disclosure, as shown in FIG. 1, includes a lens holding member 2 capable of holding a lens body LS, which is an example of an optical element, a base member 8 having an opening 8K which extends in the vertical direction and corresponds to (face) the lens body LS, a actuator DM for moving the lens holding member 2 relative to the base member 8, and a supporting member (case member 1) for supporting the base member 8. In this embodiment, the support member is composed of a case member 1 capable of containing at least a part of the base member 8. The support member (case member 1) has a base part 1B disposed on the lower surface (Z2 direction) of the base member 8 (opposite to the side on which the lens holding member 2 is disposed) and a tubular part 1C projecting upward from the inner edge of the base part 1B and disposed inside the opening 8K. As shown in FIG. 5, a foreign matter capturing member FM having adhesiveness is disposed at the rim 1CT of the tubular part 1C.

With this configuration, the lens driving apparatus 101 can prevent foreign matter such as dust, or abrasion powder from reaching the imaging sensor IS through the opening 8K of the base member 8. This is because the foreign matter capturing member FM having adhesiveness provided at the rim 1CT of the tubular part 1C of the case member 1, which is a support member located inside the opening 8K of the base member 8, can capture foreign matter. This is also because the foreign matter capturing member FM is disposed on a narrow entry route between the support member (case member 1) and the lens body LS through which foreign matter can pass.

In the illustrated example, the actuator DM is composed of a voice coil motor including the coil 3 and the magnets 5, but may be composed of other members such as a shape memory alloy wire or a piezoelectric element.

Further, as shown in FIG. 5, the foreign matter capturing member FM may be disposed not only at the rim 1CT of the tubular part 1C but also at the inner surface 1CN and the outer surface 1CE adjacent to the rim of the tubular part 1C.

This configuration has the effect that foreign matter is less likely to enter toward the imaging sensor IS than the configuration in which the foreign matter capturing member FM is disposed only at the rim 1CT, that is, the foreign matter is more reliably prevented from reaching the imaging sensor IS.

Further, the supporting member may be composed of a case member 1 formed of one or more metal plates, and may have a gap GP between the inner surface 8N of the base member 8 facing the opening 1K and the outer surface 1CE of the tubular part 1C as shown in FIG. 5.

This configuration has the effect that foreign matter can be taken into the space SP through the gap GP as shown in the lower drawing of FIG. 5, that is, the foreign matter can be captured not only at the foreign matter capturing member FM but also between the base member 8 and the tubular part 1C of the case member 1, and thus the foreign matter is more reliably prevented from reaching the imaging sensor IS. Further, this configuration having the case member 1 formed of one or more metal plates can reduce the thickness of the case member 1 (the tubular part 1C) as compared with the case member 1 formed of synthetic resin or the like, and thus has the effect that the inner diameter of the opening 1K for exposing the imaging sensor IS can be prevented from being reduced by the thickness of the tubular part 1C.

Further, the case member 1 serving as the supporting member may have an outer peripheral wall 1A positioned outside the base member 8 as shown in FIG. 2. The case member 1 formed of one or more metal plates may be included in the housing HS together with the cover member 4 formed of one or more metal plates. In this case, the case member 1 and the cover member 4 may be electrically connected to each other.

This configuration has the effect that, unlike the configuration in which at least one of the case members 1 and the cover member 4 is formed of a material other than metal plates, an electromagnetic shield function can be provided.

Further, as shown in FIG. 4, the rim 1CT of the tubular part 1C may be formed continuously along the entire circumference of the tubular part 1C. The foreign matter capturing member FM may be provided continuously along the entire circumference of the tubular part 1C.

This configuration has the effect that, compared with the configuration in which the foreign matter capturing member FM is provided intermittently along the rim 1CT of the tubular part 1C, the foreign matter is less likely to enter toward the imaging sensor IS, that is, the foreign matter is more reliably prevented from reaching the imaging sensor IS.

As shown in FIG. 6 or 7, the manufacturing method of the lens driving apparatus 101 according to the embodiment of the present disclosure includes applying a foreign matter capturing material RM, which is a synthetic resin material having fluidity, to the rim 1CT of the tubular part 1C, and curing the foreign matter capturing material RM to form a foreign matter capturing member FM having adhesiveness.

The lens driving apparatus 101 manufactured by such a manufacturing method can suppress foreign matter such as dust, or abrasion powder from reaching the imaging sensor IS through the opening 8K of the base member 8. This is because the foreign matter can be captured by the foreign matter capturing member FM having adhesiveness provided at the rim 1CT of the tubular part 1C of the case member 1, which is a supporting member inside the opening 8K of the base member 8.

The manufacturing method of the lens driving apparatus 101 may also include combining the base member 8 and the case member 1, which is a supporting member, after curing.

This manufacturing method has the effect of suppressing the foreign matter capturing material RM from adhering to the base member 8 when the base member 8 and the case member 1 are combined. This is because the foreign matter capturing material RM has already been cured during the combining.

Further, as shown in the second state view of FIG. 6, the applying may be performed by bringing the rim 1CT of the tubular part 1C of the case member 1, which is an upside-down support member, into contact with the foreign matter capturing material RM stored in the container CR.

This manufacturing method has the effect that workability can be improved as compared with a manufacturing method including applying the foreign matter capturing material RM to the rim 1CT using a nozzle or the like. That is, this manufacturing method has the effect that the foreign matter capturing material RM can be easily applied to the rim 1CT.

Further, as shown in the third state view of FIG. 6, the curing may be performed by irradiating the rim 1CT with ultraviolet light UV while the case member 1, which is a support member, is positioned upside down.

This manufacturing method has the effect that workability can be improved as compared with a manufacturing method including returning the upside-down case member 1 to the original position before irradiating the rim 1CT with ultraviolet light UV.

The applying may be performed by a transfer process as shown in FIG. 7. In the example shown in FIG. 7, in the applying, the foreign matter capturing material RM adhering to the rim SCT of the tubular part SC of the stamper ST is transferred to the rim 1CT of the case member 1.

This manufacturing method has the effect of improving workability as a compared with manufacturing method including applying the foreign matter capturing material RM to the rim 1CT using a nozzle or the like. This is because the foreign matter capturing material RM adhering to the rim SCT of the tubular part SC of the stamper ST is transferred to the rim 1CT of the case member 1 simply by bringing the rim SCT of the tubular part SC of the stamper ST into contact with the rim 1CT of the tubular part 1C of the case member 1.

The preferred embodiment of the present disclosure has been described in detail. However, the present invention is not limited to the embodiments described above. Various modifications, substitutions, and the like can be applied to the embodiments described above without departing from the scope of the present invention. Also, each of the features described with reference to the embodiments described above may be suitably combined as long as there is no technical conflict.

The present application is based on and claims priority to Japanese patent application No. 2023-168408 filed on Sep. 28, 2023, with the Japanese Patent Office, the entire contents of which are hereby incorporated by reference.

What is claimed is:

1. A lens driving apparatus comprising:
a lens holding member configured to hold a lens body;
a base member having an opening penetrating in a vertical direction thereof, the opening being at a position corresponding to the lens body;
an actuator configured to move the lens holding member relative to the base member; and
a supporting member configured to support the base member,
wherein the supporting member includes a base part disposed beneath the base member, and a tubular part protruding upward from an inner edge of the base part and disposed inside the opening, and
a foreign matter capturing member having adhesiveness is disposed at a rim of the tubular part.

2. The lens driving apparatus according to claim 1, wherein the foreign matter capturing member is disposed also at an inner surface and an outer surface of the tubular part adjacent to the rim of the tubular part.

3. The lens driving apparatus according to claim 1, wherein the supporting member is composed of a case member formed of one or more metal plates, and has a gap between an inner surface of the base member facing the opening and an outer surface of the tubular part.

4. The lens driving apparatus according to claim 1,
wherein the supporting member is composed of a case member formed of one or more metal plates,
wherein the case member has an outer peripheral wall positioned at an outer position relative to the base member, and is included in a housing together with a cover member formed of one or more metal plates, and
wherein the case member and the cover member are electrically connected to each other.

5. The lens driving apparatus according to claim 1, wherein the foreign matter capturing member is provided continuously along an entire circumference of the tubular part.

6. A camera module comprising:
the lens driving apparatus of claim 1;
the lens body; and
an imaging sensor facing the lens body.

7. A method of manufacturing a lens driving apparatus which includes:
a lens holding member configured to hold a lens body;
a base member having an opening penetrating in a vertical direction thereof, the opening being at a position corresponding to the lens body;
an actuator configured to move the lens holding member relative to the base member; and
a supporting member configured to support the base member,
wherein the supporting member includes a base part disposed beneath the base member, and a tubular part protruding upward from an inner edge of the base part and disposed inside the opening,
the method comprising:
applying a foreign matter capturing material, which is a synthetic resin material having fluidity, to a rim of the tubular part; and
curing the foreign matter capturing material to form a foreign matter capturing member having adhesiveness.

8. The method according to claim 7, further comprising combining the base member and the supporting member, after the curing.

9. The method according to claim 7, wherein the applying is performed by bringing the rim of the tubular part of the support member positioned upside down into contact with the foreign matter capturing material stored in a container.

10. The method according to claim 9, wherein the curing is performed by irradiating the rim with ultraviolet light while the support member is positioned upside down.

11. The method according to claim 7, wherein the applying is performed by a transfer process.
